(19) United States
(12) Patent Application Publication
(10) Pub. No.: US 2019/0360687 A1
(43) Pub. Date: Nov. 28, 2019

(54) HORIZONTAL KNOB LOCKOUT DEVICE FOR GAS-FIRED APPARATUSES, SUCH AS GAS STOVES OR SIMILAR

(71) Applicant: Universidad Nacional de Itapua, Encarnacion (PY)

(72) Inventors: Waldy Anibal RIVEROS SAAVEDRA, Pilar Neembucu (PY); Fernando Luis GALEANO FLORES, Hohenau - Itapua (PY); Ricardo Hideto MATSUNAGA MASAOKA, La Paz - Itapua (PY); Sandra Isabel KALLUS LOBSIGER, Bella Vista - Itapua (PY); Rodney DELGADO, Cocle - Panama (PY)

(21) Appl. No.: 16/030,556

(22) Filed: Jul. 9, 2018

(30) Foreign Application Priority Data
May 25, 2018 (PY) P 1839491

(51) Int. Cl. F23D 14/72; F16K 35/02; F24C 3/12

(52) U.S. Cl. CPC F23D 14/72; F24C 3/12; F16K 35/025

(57) ABSTRACT

The present invention relates to a device made of metal bars or other resistant materials, intended for locking the rotary knobs that enable the circulation of gas in ranges, stoves or similar apparatuses, wherein said device comprises a sliding horizontal lockout knob behind the burners, connected to a control bar which, in turn, is connected or welded to a front bar that slides over rollers when the gas release knobs must be locked. Thus, lockout is achieved by means of a wedge that is part of the control rod and which is inserted in a hole made in the cylindrical shaft of the circulation knobs. The device is used as a safety system against poisonings, explosions or fires, which might occur upon accidentally releasing the circulation of gases.

### CROSS REFERENCE TO RELATED APPLICATION

This application claims priority of Paraguay Application No. P 1839491 PY filed May 25, 2018, application which is incorporated herein by reference.

### FIELD OF THE INVENTION

The present invention can be included in the technical field of domestic and industrial safety, particularly that related to accidental poisonings, explosions and fires, arising from the loss of gases in apparatuses that use gas, inter alia, as fuel for heating or heating and cooking food. More specifically, the object of the invention relates to a device for horizontally locking knobs on ranges or said apparatuses that use gas as a fuel, as mentioned earlier.

Specifically, the present invention relates to a device manufactured from a series of metal bars or other highly resistant materials, intended for horizontally locking the rotary knobs that enable gas circulation in ranges, stoves or similar apparatuses, wherein said apparatus comprises a sliding lockout knob in the area behind the burners, connected to a control bar, which in turn is connected or welded to a front bar that slides over rollers in order to lock the gas release knobs. Thus, lockout is achieved by means of a wedge which is part of the control rod and is inserted in a hole made in the cylindrical shaft of the circulation knobs. The device is used as a safety system against poisonings, explosions or fires, which might occur upon accidentally releasing the circulation of gases.

### BACKGROUND OF THE INVENTION

There are currently many accidents related to gas leakages in gas-fired ranges or apparatuses, the vast majority of which occur due to the negligence of users or persons passing by and who make improper use of the knobs or valves that enable the passage of gas from its supply to the burner. This problem increases considerably in the case of households, since in most cases there are children who can handle the knobs and generate the fuel release, which goes unnoticed by the adult at the time.

Therefore, there are times when it is necessary to ensure the closure or lockout of the gas circulation release knobs in ranges and stoves, to prevent the accidental release thereof, thereby increasing the chances of an explosion and subsequent fire, and also poisoning of people. A probable case is the tampering of knobs by children, which then leave them open, causing gas leakages that give rise to catastrophic results that even include death in some cases.

In this connection, in the state of the art there are a plurality of disclosures related to apparatuses or systems for estimating or measuring a user's body variables, including document KR 484929, which defines a flow structure for a stove valve having a body equipped with an inlet such that combustion gas is injected when a safety system is disposed on one side of the main body. Also, a central passage is formed on one internal side of the main body, forming a combustion gas fluid pathway. A gas passage is connected to the central passage and a knob shaft is also disposed on the main body, wherein said knob opens the safety system to inject combustion gas at the gas inlet and outlet of the main body through the safety system.

There is also document CA 2909321, which discloses a gas-fired electrical appliance, such as a stove, having an electromagnetic unit magnetically associated with a movable assembly which enables the change in position of the movable assembly when fed electrical pulses. A shut-off valve comprises a manual actuator to move the movable assembly together with an open position wherein it is uncoupled from the movable assembly, whereby an electromagnetic actuator capable of acting on the closure unit causes closure thereof.

Also, document WO 2005096695 discloses a storage system for hazardous gas using metal canisters and requires a valve assembly for controlling the safe delivery of gas to the application. The system comprises a shut-off valve assembly is in sequential series with the flow control valve, wherein said shut-off valve provides a secondary seal during storage outside of the application system that reduces the risk of undesirable hazardous gas releases, thereby preventing access to the primary seal or flow control valve and preventing tampering with the internal mechanism, avoiding safety hazards. The shut-off valve is preferably opened by a pin that depresses a secondary seal stopper when the connection is established. The flow control valve is magnetically actuated by a magnetic flux generated by a coil. In this manner, when an electric signal is sent to the coil, the armature moves to the open position to open the primary seal, thereby allowing gas to flow through the valve into the application system.

Additionally, there is also document K 541721, which discloses a safety device for gas stoves to force shut-off of the gas supply after a predetermined time upon rotating an ignition and control lever or knob to an original position by operating a motor, wherein the ignition and control knob of the gas-fired apparatus is rotated using the rotation energy of the motor and a gas barrier and configures the electronic valve, and the valve automatically locks the interception valve and measures the control box controller and lights the stove or gas oven.

Furthermore, there is document U.S. Pat. No. 4,346,701, which corresponds to a gas administration apparatus corresponding to a gas administration unit for anaesthesia and life support and only operates when positively locked at the gas supply outlet, wherein said apparatus includes an interlock system which prevents a valve for controlling the admission to the unit of gas from a supply provided by the apparatus from being operated before a locking mechanism has locked the unit to the anaesthesia machine. The interlock system also includes actuating means which, when the unit is mounted on the anaesthesia machine, opens respective valve members in ports located on the anaesthesia machine only when the control valve is moved to its operating position.

There are also systems that use knobs with a releasable lock that prevents a switch or valve from igniting, but the system is complicated, using a lock with a movable pin such as that defined in document U.S. Pat. No. 5,771,878 by Lewis et al. (June 1998).

Furthermore, there are disclosures of knobs having valves with a thermoelectric safety device such as that defined in U.S. Pat. No. 6,886,581 by Harniet (May 2005), but it does not consider locking the knob, but rather on the contrary reduces the size of this type of valves, improving their internal mechanism.

In accordance with the information provided in the preceding paragraphs, it can be observed that current solutions disclose different mechanisms or devices for locking valves or knobs used in gas-fired systems; however, none of said documents combines a sliding locking knob located in the area behind the burners, connected to a transverse prismatic bar or control bar, which in turn is welded or connected to a main rod or front prismatic bar; wherein the main rod or front prismatic bar has rollers and has a projection called locking wedge (in the manner of a flange), which can be inserted in a hole made in the cylindrical shaft of the gas circulation knob to be locked, while the transverse or control prismatic bar moves up to a sliding stop.

Therefore, it can be stated that there is a need in the state of the art to design and implement a device as an alternative for increasing safety when handling gas in ranges, stoves and similar apparatuses, with a simple and completely mechanical system, without electrical or pneumatic parts and electronic controls that would increase the cost and complications of maintaining the apparatus.

### SUMMARY OF THE INVENTION

The present invention is aimed at a device made of metal bars or other resistant materials, aimed at blocking the rotary gas circulation knobs in ranges or similar apparatuses, wherein said device is used as a safety system against poisonings, explosions or fires.

To this end, the main rod of the device has flanges that are introduced in each hole made in the shaft of the knobs and prevent it from rotating, wherein the main or front rod is joined to a control rod having a locking slide or knob which indirectly enables the insertion of flanges or wedges in the knobs and detach them when they are no longer necessary.

Thus, the control rod prevents the rotation of the gas circulation knob, since it is disposed welded to the main or front rod, perpendicular thereto, while the closure and opening slide forms part of the control rod, and slides over a rectangular opening located behind the burner area.

Therefore, the main objective of the device of the present invention is to increase safety when handling gas in ranges, stoves and similar apparatuses, by means of a simple and completely mechanical system, without electrical and pneumatic parts and electronic controls that might increase the cost and complications of maintaining and operating the apparatus based on gas as a fuel.

### BRIEF DESCRIPTION OF THE FIGURES

The present invention is more readily understandable from the following figures, which show the different components, parts or steps associated with the present device, apparatus, system or method, in addition to the novel elements with respect to the state of the art, wherein the figures do not intend to limit the scope of the invention, which is solely determined by the attached claims, wherein:

FIG. 1 shows a perspective view of the horizontal lockout device of the resent invention.

FIG. 2 shows a top view of the device of FIG. 1.

FIG. 3 shows a perspective view of the area corresponding to the gas release knob, its shaft and the lockout wedge, of the device of the present invention.

FIG. 4 shows a side view of the lockout device of the invention, taking into consideration a single gas knob, including the lockout knob.

### DETAILED DESCRIPTION OF THE INVENTION

The foregoing described figures are not drawn to scale. The current dimensions for each of the components may vary according to the user's needs. The most significant details of the device of the invention are highlighted so that a person not skilled in the art may appreciate the concept more clearly.

The present invention is aimed at a horizontal lockout device for locking the knobs of a cooking or gas-fired apparatus, which is based on the use of a series of rods or bars disposed such that the multiple gas supply flow release knobs of the apparatus wherein it is installed can be achieved with the movement of a single lever. Although the use of mainly four knobs is envisaged for a gas-fired stove, it is simply an illustrative modality that corresponds to the normal amount of burners of a conventional stove; however, the use of from a single knob (i.e. stove with a single burner) to the lockout of multiple knobs, without limitation, is also envisaged, since the amount of knobs to be operated or controlled will depend on the length of the elements, as they will be defined below.

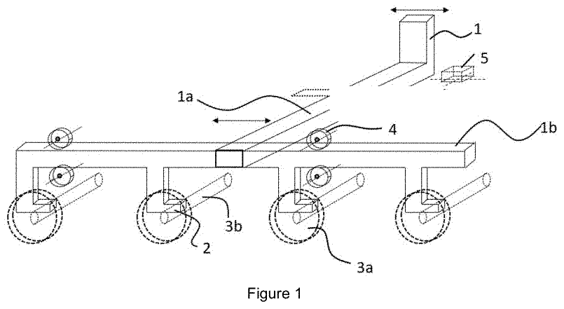

Therefore, the device of the present invention comprises the following components and/or parts, wherein the function and interaction of each of them is defined below:
A lockout lever or knob 1, which is preferably located at the back of the gas-fired apparatus to be controlled, wherein said lockout lever or knob 1 enables the simultaneous lockout of multiple gas supply release knobs of the apparatus where it is installed;
A transverse bar 1a located perpendicular to the lockout lever or knob 1 and joined thereto by means of any rod-joining method, such as welding, adhesive, mechanical connection (screws or similar), etc., wherein the transverse bar 1a extends from the lower end of the lockout lever or knob 1 to a front bar 1b;
A front bar 1b which is disposed perpendicular to the transverse bar la and on the horizontal plane, i.e. it is also perpendicular to the lockout lever or knob 1, as shown in FIG. 1, wherein said front bar 1b corresponds to the element that interacts with the lockout elements of each of the knobs of the apparatus;
One or more lockout wedges 2 disposed on one or more projections that extend perpendicularly downwards from the front bar 1b, forming an “L”, wherein the number of lockout wedges 2 and, thus, of the projections of the front bar 1b will depend directly on the amount of knobs of the apparatus to be controlled;
One or more knobs 3a of the apparatus, which has a knob shaft 3b at the back thereof, in whose interior there is a hole 3c that coincides exactly in size and shape with one or more lockout wedges 2, wherein said hole 3c is intended for receiving each of the lockout wedges 2 for the purpose of locking the rotation of each of the knobs 3a;
Rollers 4 disposed on the front part of the device and at the top and bottom of the front bar 1b, in direct contact therewith, such as to enable said front bar 1b to slide laterally on the horizontal plane; and 1 A stop or end-of-travel 5 disposed at the back of the device on one of the sides of the lockout lever or knob 1, wherein said travel stop 5 defines the end-of-travel position of the lockout lever 1, transverse bar 1a, front bar 1b and lockout wedge 2 assembly.

In this manner, FIG. 1 shows a perspective view of the device of the present invention, wherein the lockout lever or knob 1 that would form part of the transverse prismatic bar 1a or control bar, which is welded o connected perpendicularly to the main rod or front prismatic bar 1b, forming the main body of the device. Thus, to execute the lock, the front prismatic bar 1b has at least one projection called lockout wedge 2, which extends towards the bottom of the said front bar 1b, as defined previously, which may be inserted in the interior of the cylindrical shaft 3b of the knob 3a, specifically in the hole 3c made in said shaft 3b.

Furthermore, also making reference to FIG. 1, rollers 4 are shown which allow the front prismatic bar 1b to slide correctly in both directions and, when lockout is executed, the control bar moves towards the travel stop 5, wherein said rollers 4 are located both at the top and at the bottom of the front bar 1b, thereby creating a rail for the movement of the aforementioned bar 1b so it may move laterally along the horizontal plane without vertical movements, such that each lockout wedge 2 is adequately interlocked with each knob 3a.

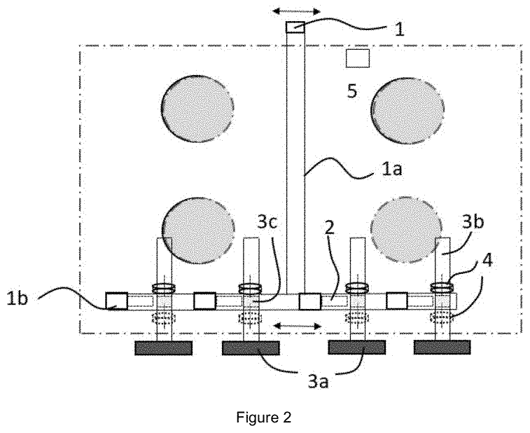

Making reference to FIG. 2, said illustration shows a top view of the device of FIG. 1, wherein the lockout knob 1 can be observed connected to the control bar 1a and is in turn connected or welded to the front bar 1b, thereby creating a rigid control structure. Thus, each lockout wedge 2 can be inserted in the hole 3c of the knob 3a in its shaft 3b as the front bar moves 1b over the rollers 4 which enable sliding up to the stop 5, as mentioned earlier.

In said FIG. 2, the functionality of the rollers 4 can also be illustrated, which make it possible to serve as a guide for the front bar 1b, in order to enable lateral movement until reaching or stopping at the travel stop 5. In the modality illustrated in FIG. 2 there is a set of rollers 4, i.e. an upper and lower roller (i.e. one above the bar 1b and one below it), for each knob 3a or for each lockout wedge 2, but it should be noted that the amount of rollers will depend directly on the user's requirements and is not limited to any specific number of knobs 3a, lockout wedges 2 or burners of the apparatus where the device of the present invention is installed.

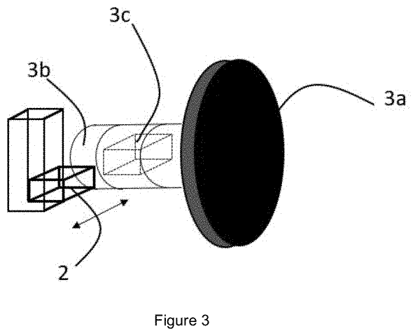

FIG. 3 shows a perspective view of the area corresponding to the gas release knob 3a, its shaft 3b and the hole 3c wherein the lockout wedge 2 is inserted, clearly illustrating that the three elements would form a complete knob of a gas-fired device, wherein the knob 3a is located at the front thereof and is in contact with the user, i.e. it is the knob handled by said user to enable the gas to flow towards the burner, the shaft 3b is located exactly behind the knob 3a and emerges therefrom perpendicularly, housing in its interior the hole 3c that will enable the insertion of the lockout wedge 2 therein when the lockout lever or bar 1 is actuated by the user by means of a lateral movement thereof.

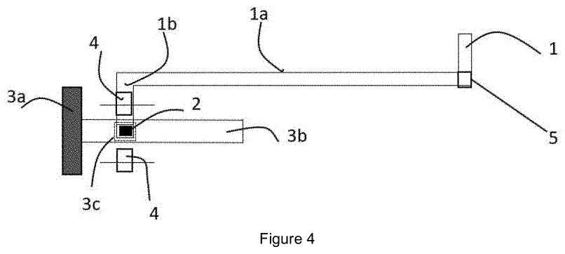

Lastly, FIG. 4 shows a side view of the lockout device of the present invention illustrating only a single gas circulation knob 3a, wherein the lockout knob 1 can be observed connected to the control bar 1a and the latter in turn to the front bar 1b. Also, the lockout wedge 2 can be observed inside the hole 3c of the gas knob 3a with its shaft 3b and the sliding rollers 4 whereover the front bar 1b moves.

In one modality of the present invention, the entire lockout bar system composed by the lockout lever or knob 1, the transverse bar 1a and the front bar 1b, together with the projections or lockout wedges 2, are manufactured from a highly resistant material, preferably metal, for the purpose of obtaining a completely rigid and resistant structure that can be actuated or handled by the user without risk of breaking and leaving the operation of the knobs open or with gas leakages at any given time.

In another alternative modality, the device of the present invention may have an additional travel stop 5, which is disposed on the opposite end of the previously defined stop 5, i.e. in this modality two travel stops 5 will be disposed, one on either side of the transverse bar 1a on the lockout lever or knob 1 part, for the purpose of defining the two ends-of-travel of the entire lockout structure, i.e. in order to indicate the end-of-travel position of the lockout lever or knob 1 to unlock the operation of the knobs 3a or in order to indicate the end-of-travel position of said lever 1 to lock the operation of the aforementioned knobs 3a.

1. A horizontal knob lockout device for gas-fired apparatuses, comprising:
a lockout lever or knob, which enables the simultaneous lockout of multiple gas supply release knobs;
a transverse bar located perpendicular to the lockout lever or knob, wherein the transverse bar extends from the lower end of the lockout lever or knob to a front bar;
a front bar disposed perpendicular to the transverse bar, wherein said front bar has one or more projections that extend therefrom to the lower part in a vertically perpendicular manner;
one or more lockout wedges disposed on each of the projections of the front bar, forming an “L”;
one or more knobs having a knob shaft at the back part thereof, in whose interior there is a hole that coincides exactly in size and shape with one or more lockout wedges;
rollers disposed on the front part of the device and at the top and bottom of the front bar, in direct contact therewith, which enable said front bar, in direct contact therewith, which enable said front bar to slide laterally on the horizontal plane; and
a travel stop disposed at the back of the device on one of the sides of the lockout lever or knob, wherein said travel stop defines the end-of-travel position of the lockout lever, transverse bar, front bar and lockout wedge assembly.

2. The lockout device, according to claim 1, wherein the number of lockout wedges and projections of the front bar correspond to the amount of knobs to be controlled.

3. The lockout device, according to claim 1, wherein the rollers are disposed in pairs per each knob or per each lockout wedge.

4. The lockout device, according to claim 1, wherein the main body composed by the lockout lever or knob, the transverse bar and the front bar, together with projections or lockout wedges, are manufactured from a highly resistant material, such as metal.

5. The lockout device, according to claim 4, wherein the elements of the main body are joined together by welding, adhesive or mechanical connection, such as by mean of screws or similar.

6. The lockout device, according to claim 1, comprising an additional travel stop disposed on the opposite end of the original travel stop, i.e. one on either side of the transverse bar on the lockout lever or knob part.
